(19) United States
(12) Patent Application Publication
(10) Pub. No.: US 2012/0116910 A1
(43) Pub. Date: May 10, 2012

(54) Real estate auction method

(76) Inventor: Andre Danesh, Brookline, MA (US)

(21) Appl. No.: 13/373,160

(22) Filed: Nov. 7, 2011

Related U.S. Application Data
(60) Provisional application No. 61/456,441, filed on Nov. 8, 2010.

(51) Int. Cl. G06Q 30/08

(52) U.S. Cl. 705/26.3

(57) ABSTRACT

This invention relates to method for using a computer to facilitate an auction of an interest in real estate on the World Wide Web wherein an owner inputs into a computer relevant parameters pertaining to the real estate interest on offer. The real estate interest and related data are then posted on a website on the World Wide Web to create a searchable database which is made available to prospective purchasers. Prospective purchasers may to submit a conditional offer or offers to purchase the selected real estate interest which is transmitted to the owner of the real estate interest on offer. If the property on offer receives multiple offers, the respective conditional offers to purchase are posted on the website to encourage additional higher offers. The provider of the website earns a fee for the service of connecting the buyer and seller of the subject interest in real estate.

### PRIOR APPLICTION

This application claims priority of provisional patent application Ser. No. 61/456,441 filed Nov. 8, 2010.

### FIELD OF THE INVENTION

This invention relates generally to the field of auctions, and more particularly to the field of auctions of real estate, notes and mortgages, leases and other assets appurtenant to real estate.

### BACKGROUND OF THE INVENTION

There are many methods of selling property such as retail outlets, wholesale outlets, brokers and agents, and auctions. In some instances the auction market is preferred because the sale can be arranged relatively quickly and, with a properly advertised auction, it is the market which determines the ultimate sales price.

Auctions are well known and have been a method of selling for hundreds of years. There are also multiple types of auctions. For example, there is the “regular” auction that is most common wherein bidders increase the price until there is only one bidder left, who has offered the most money, known as the “high bid” and who then becomes the owner of the item being on offer. There is also the “Dutch auction” made famous by the tulip bulb mania or “bubble” of seventeenth century Holland. In a Dutch auction, the item on offer starts with a high offer price which is steadily lowered until a purchaser accepts the offer price.

Virtually any conceivable item may be sold by the auction method. One auction category covers the antiques and fine arts. Included in this category are furniture, silver, painting, sculpture, stamps, coins, antiquities, arms and armor and other highly valued or rare items.

Another type of auction covers merchandise such as those found in department stores, which is perhaps exemplified by the Ebay model. Yet another type of auction is the stock and commodities markets wherein there is a bid and ask price for the securities and/or commodities on offer. A sale is concluded when the bid and offer prices match with a small commission being taken by the middle man or market maker.

Notwithstanding the foregoing, there is no ready auction market through bidding for real estate ownership interests and if a market exists, it is generally inefficient and purely local. The notion of owning real estate can be broken into a number of rights. For example one such right is ownership of the land and all of the improvements that are situated thereon. Other appurtenances are mineral rights, water rights, air rights and easement across the land. Additionally, other rights associated with real estate are leases and the right to receive the income stream from said lease. Further, each of the aforementioned rights may be bought and sold separately, or even in tranches, however, no ready auction market exists. Thus, it will be seen that in large measure, real estate transactions can be unique and many are not subject to “securitization” which has been in the headlines as of late. This makes the sale of real estate interests difficult, especially in the secondary market.

In view of the foregoing, it is an object of the present invention to provide an improved auction market for real estate ownership interests.

Another object of the present invention is to provide an auction market for real estate ownership interests which is transparent.

Yet another object of the present invention is to provide an auction market for real estate ownership interests which is capable of handling transactions on a national or international basis.

Still another object of the present invention is to provide an auction market for real estate interests, which is economically efficient.

A still further object of the present invention is to provide a forum wherein sellers may advertise a real estate interest for sale and solicit offers therefore.

A still further object of the present invention is to provide a central exchange wherein prospective purchasers of real estate interests may consult in order to examine the properties on offer and if interested, make purchase offers.

### SUMMARY OF THE INVENTION

These and other objects are accomplished by providing a method for using a computer to facilitate an auction of an interest in real estate on the World Wide Web. According to the method an owner inputs into a computer relevant parameters pertaining to the real estate interest on offer, the parameters being selected from the group consisting of location, legal description, physical data, photography, tax data, special assessment data, appraisal data, condition data, lease data, occupancy data, financial information data, mortgage data and lien data. The real estate interest and related data are then posted on a website on the World Wide Web to create a searchable database; the searchable database including parameters selected from the group consisting of location, physical data, tax data, appraisal data, lease data, occupancy data, financial information data and mortgage data. The database is then broadcasted or otherwise made available to prospective purchasers who may search the real estate interests on offer. Prospective purchasers, if interested may to submit a conditional offer or offers to purchase for the selected real estate interest and the conditional offer to purchase is transmitted to the owner of the real estate interest on offer. If the property on offer receives multiple offers, the respective conditional offers to purchase are posted on the website to encourage additional higher offers. The provider of the website earns a fee for the service of connecting the buyer and sell of the subject interest in real estate.

### DETAILED DESCRIPTION OF THE PREFERRED EMBODIMENT

While the present invention will be described more fully hereinafter with reference to the accompanying drawings, in which a particular embodiment is shown, it is to be understood at the outset that persons skilled in the art may modify the invention herein described while still achieving the favorable results of this invention. Accordingly, the description which follows is to be understood as a broad teaching disclosure directed to persons of skill in the appropriate arts and not a limiting upon the present invention.

According to the present invention a method for using a computer to facilitate an auction of an interest in real estate on the World Wide Web is initiated. According to the method the owner of an interest in real estate inputs into a computer relevant parameters pertaining to the real estate interest on offer such as location, legal description, physical data, photography, tax data, special assessment data, appraisal data, condition data, lease data, occupancy data, financial information data, mortgage data and lien data (hereinafter referred to as “parameters”).

The parameters are then posted on a website on the World Wide Web with specific reference to the real estate interest in such a manner that a searchable database is created. The searchable database includes parameters selected from the group consisting of location, physical data, tax data, appraisal data, lease data, occupancy data, financial information data and mortgage data and the database is then made available to prospective purchasers so that they may search the real estate interests on offer. The foregoing acts to consolidate, in a central location, disparate real estate interests. For example, an investor may only be looking to purchase a mortgage having only five (5) years left before the note is entirely paid off or a mortgage is in default. Similarly, a seller may own mineral rights and the accompanying royalty from a natural gas well on his property and may have need for immediate cash and wants to sell the future revenue stream for a lump sum. Another scenario is wherein a seller may have obtained an option to purchase a tract of land which is suitable for a fast food restaurant and wishes to make said option available for purchase in an auction sale to various fast food chains.

In the foregoing scenarios, the prospective purchasers after searching the website may submit a conditional offer or offers to purchase for the selected real estate interest. The conditional offer to purchase to the owner of the real estate interest on offer is transmitted to the seller and may also posted on the portion of the website such that all of the conditional offers to purchase are viewable by other bidders relating to the selected property in order to encourage subsequent higher offers. Thereafter, additional prospective purchasers may submit offers to purchase. This process is repeated until the Seller accepts an offer to purchase or the posted duration of the auction expires.

Upon completion of an auction by time the seller then has to decide whether the highest conditional offer to purchase is acceptable or not. If the highest conditional offer to purchase is satisfactory, the seller will accept the offer and the auction will move to the due diligence and thereafter, closing of the transaction. On the other hand, if the highest conditional offer to purchase is not acceptable to the seller, the offer is rejected and the auction ends. In the event the auction ends without a purchase having been concluded, the seller may re-post the property in the database for another auction as new investors/purchasers having different requirements are continually entering and leaving the market. In addition, based on the first offers received, the seller may have learned that his intended sale price is too high and may choose to amend his parameters of what an acceptable offer would look like or may lower his expectations. Similarly, an investor having made several unsuccessful offers may have to adjust his offer price upward in order to conclude a transaction.

A successful conditional offer to purchase may be accompanied by a deposit which may be refundable or not, depending on the seller's conditions. Further, an accepted offer will include a time period for the purchaser to conduct due diligence in order to establish the veracity of the seller's representations and in all likelihood will retain legal counsel in the vicinity of the property to ensure that he receives clear title to the interest purchased. If all of the conditions precedent to the closing are satisfied, the seller will transmit the funds to counsel who will close the transaction and forward the purchase proceeds to the seller upon receipt of proper documentation transferring title to the purchaser.

The website provider earns a fee or remuneration for providing the forum for connecting the buyer and seller of the subject interest in real estate. This fee may be a flat fee for providing the forum or based on a percentage of the value of the interest transferred and may or may not be contingent on the closing of the transaction.

In the specification that has been set forth herein, there are preferred embodiments of the invention and, although specific terms are employed, they are used in a generic and descriptive sense only and not for purposes of limitation, the scope of the invention being described in the claims.

That which is claimed is:

1. A method for using a computer to facilitate an auction through bidding in real estate, notes and mortgages, leases and other interests appurtenant to real estate on the world wide web comprising the steps of:
inputting by the owner into a computer relevant parameters pertaining to the real estate interest on offer, the parameters being selected from the group consisting of location, legal description, physical data, photography, tax data, special assessment data, appraisal data, condition data, lease data, occupancy data, financial information data, mortgage data and lien data;
posting the real estate interest and related data on a website on the world wide web to create a searchable database; the searchable database including parameters selected from the group consisting of location, physical data, tax data, appraisal data, lease data, occupancy data, financial information data and mortgage data;
providing the database to prospective purchasers to search the real estate interests on offer;
inviting the prospective purchasers to submit a conditional offer or offers to purchase for the selected real estate interest;
transmitting the conditional offer or offers to purchase to the owner of the real estate interest on offer.

2. The method according to claim 1 wherein the auction lasts for a preselected period of time.

3. The method according to claim 1 further including the step of posting the respective conditional offers to purchase on the website such that all of the respective conditional offers to purchase are viewable to other potential bidders to encourage additional higher offers.

4. The method according to claim 1 wherein the seller has the option to accept or reject the highest conditional offer to purchase at the time the auction ends.

5. The method according to claim 1 further including the step of allowing a preselected period of time for the purchaser submitting the conditional offer to purchase to conduct due diligence concerning the veracity of the seller's representations.

6. The method according to claim 5 wherein the step of conducting due diligence further includes retaining counsel to consummate the transaction.

7. The method according to claim 1 further including the step of providing remuneration to the owner of the website hosting the real estate auction.

8. The method according to claim 8 wherein the remuneration may or may not be conditional on closing the transaction.

9. The method according to claim 8 wherein the remuneration is based on a combination of a fee for providing the forum for real estate auction and a fee based on the value of the closed transaction.
